(19) United States
(12) Patent Application Publication
(10) Pub. No.: US 2005/0242581 A1
(43) Pub. Date: Nov. 3, 2005

(54) Coupler

(76) Inventors: Michael D. Nowling, Clayton, IN (US); Ronald J. Cress, Indianapolis, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/155,978

(22) Filed: Jun. 17, 2005

Related U.S. Application Data
(63) Continuation of application No. 10/453,969, filed on Jun. 4, 2003.
(60) Provisional application No. 60/386,470, filed on Jun. 5, 2002.

(51) Int. Cl. F16L 47/00

(52) U.S. Cl. 285/307

(57) ABSTRACT

A coupler is provided for coupling a plurality of tubes together. The coupler includes a base member and one or more fittings. Each fitting couples one or more tubes together. The coupler further includes a retainer that secures one or more fittings to the base member.

### RELATED APPLICATIONS

This application is a continuation of U.S. patent application Ser. No. 10/453,969, titled “COUPLER”, filed Jun. 4, 2003 to Nowling et al. which claims benefit of U.S. Provisional Patent Application Ser. No. 60/386,470 titled “MANIFOLD” filed Jun. 5, 2002 to Nowling et al., the disclosures of which are expressly incorporated by reference herein.

### BACKGROUND AND SUMMARY OF THE INVENTION

The present invention relates to couplers. More particularly, the present invention relates to couplers having a plurality of connectors configured to connect a plurality of tubes.

It is known to have fittings which connect a first tube and a second tube. Further, it is known to include fittings in a frame that connects to a bulkhead.

In one exemplary embodiment, the present invention includes a coupler configured to couple a plurality of first and second tubes together. The coupler includes a plurality of fittings. Each fitting includes a fitting body having a step, a first end adapted to be coupled to a first tube, and a second end adapted to be coupled to a second tube to provide fluid communication between the first and second tubes. The coupler further includes a holder including a plurality of apertures configured to receive the plurality of fittings. The holder interacts with the step of the plurality of fittings to restrict the movement of the plurality of fittings along a longitudinal axis of the plurality of apertures.

In another exemplary embodiment, the present invention includes a coupler configured to couple a plurality of first and second tubes together at a bulkhead. The bulkhead has a first side and a second side. The coupler includes a base member adapted to be coupled to the bulkhead, a plurality of fittings, and a retainer. The base member has a first side which is accessible from the first side of the bulkhead, a second side which is accessible from the second side of the bulkhead, and a plurality of apertures extending from the first side of the base member to the second side of the base member. Each fitting has a first end adapted to be coupled to a first tube and a second end adapted to be coupled to a second tube. Each of the plurality of fittings is received by the respective aperture of the plurality of apertures from the first side of the base member; The retainer is configured to secure at least one of the plurality of fittings to the holder. The retainer is positioned from the first side of the holder such that at least one of the plurality of fittings is coupled to the holder.

In a further exemplary embodiment, the present invention includes a coupler configured to couple a plurality of first tubes to a plurality of second tubes. The coupler includes a plurality of fittings and a base member. The fittings have a first end adapted to be coupled to a first tube and a second end adapted to be coupled to a second tube. The base member includes a plurality of apertures configured to receive the plurality of fittings. A first of the plurality of fittings extends through a first aperture of the plurality of apertures. The coupler further includes a retainer to secure the first fitting in the first aperture of the plurality of apertures.

### BRIEF DESCRIPTION OF THE DRAWINGS

A detailed description particularly refers to the accompanying figures in which:

FIG. 1 is a diagrammatic view of an exemplary coupler showing the coupler connected to a bulkhead and configured to connect a first tube to a second tube;

FIG. 2 is a diagrammatic view of the exemplary coupler of FIG. 1 showing the coupler including a plurality of fittings secured to a holder;

FIG. 3 is a diagrammatic view of an exemplary fitting of the coupler of FIG. 1 showing the fitting including a first end configured to couple a first tube, a second end configured to couple a second tube, and at least one step positioned between the first and second ends;

FIG. 4 is a side elevation view of another exemplary connector or fitting;

FIG. 5 is a cross-sectional view of the connector of FIG. 4 taken along line 5-5 of FIG. 4;

FIG. 6 is an assembly view of the connector of FIG. 4;

FIG. 7 is a perspective view of another exemplary coupler showing the coupler including a plurality of fittings and a holder including a base member and a plurality of retainers configured to retain the fittings in the holder;

FIG. 8 is a top view of the base member of FIG. 7 showing the base member including a plurality of apertures having circular portions with first and second diameters;

FIG. 9 is a bottom view of a first retainer of FIG. 7;

FIG. 10 is a side view of the first retainer of FIG. 9;

FIG. 11A is a cross-sectional view of a portion of the base member of FIG. 7, a pair of the fittings, and a first retainer showing the first retainer and the pair of fittings being spaced-apart from the base member;

FIG. 11B is a view similar to FIG. 11A showing the coupler in a loading configuration with the pair of fittings positioned in a pair of apertures defined in the holder;

FIG. 11C is a view similar to FIG. 11B showing the pair of fittings positioned in the pair of apertures such that a first step of each fitting abuts a surface defining the respective aperture;

FIG. 11D is view similar to FIG. 11C showing the coupler in a secured configuration with the pair of fittings secured in the positions shown in FIG. 11C by the first retainer that is positioned in the pair of apertures;

FIG. 12 is a bottom view of a second retainer of the coupler of FIG. 7;

FIG. 13 is a side view of the second retainer of FIG. 12;

FIG. 14 is a cross-sectional view of the second retainer of FIG. 12 taken along line 14-14 of FIG. 12 showing the second retainer including a body member and an exemplary latch;

FIG. 15 is a cross-sectional view of another exemplary latch showing the latch engaged with a base member;

FIG. 16 is a cross-sectional view of the coupler of FIG. 7 taken along line 16-16 of FIG. 7 showing the coupler in a secured configuration with a fitting secured by the second retainer positioned in an aperture in the base member;

FIG. 17 is a side elevation view of an inner plate or base member of another exemplary coupler showing the base member including a plurality of apertures having circular portions with first and second diameters;

FIG. 18 is an end view of the inner plate of FIG. 17;

FIG. 19 is a side elevation view of one of a pair of outer plates or retainers for use with the inner plate of FIG. 17 showing the plate including a plurality of elongated apertures;

FIG. 20 is an end view of the outer plate of FIG. 19;

FIG. 21 is an enlarged view of portions of the inner and outer plates showing the inner and outer plates aligned to provide a substantially circular passage or opening therethrough;

FIG. 22 is a cross-sectional view taken along line 22-22 of FIG. 21 showing a connector (in phantom) aligned for passage into the inner and outer plates;

FIG. 23 is a view similar to FIG. 21 showing the inner plate or base member shifted downward relative to the outer plates to decrease the cross-sectional area of the passage through the inner and outer plates; and

FIG. 24 is a view similar to FIG. 22 showing the inner plate or base member shifted downward relative to the outer plates.

### DETAILED DESCRIPTION OF THE DRAWINGS

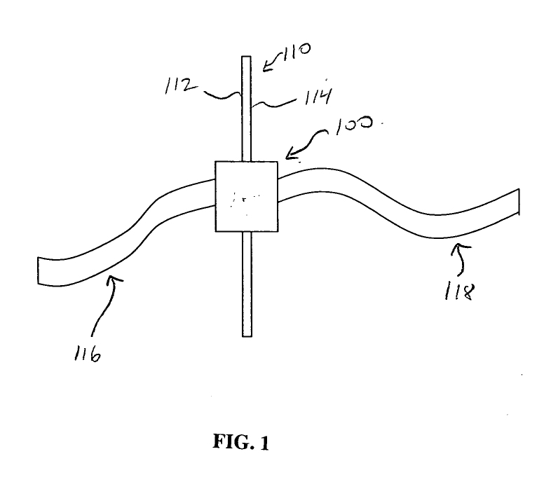

Referring to FIG. 1, a coupler 100 according to an exemplary embodiment of the present disclosure is shown. Coupler 100 is assembled or secured to a bulkhead 110 of a vehicle or other piece of equipment having a first side 112 and a second side 114. Coupler 100 couples a tube or plurality of tubes 116 to another tube or plurality of tubes 118. Tubes 116, 118 transport fluids, such as air, other gases (such as oxygen), or liquids. As such, coupler 100 couples tubes 116, 118 together such that a fluid is transported from one of tubes 116, 118 to the other of tubes 118, 116.

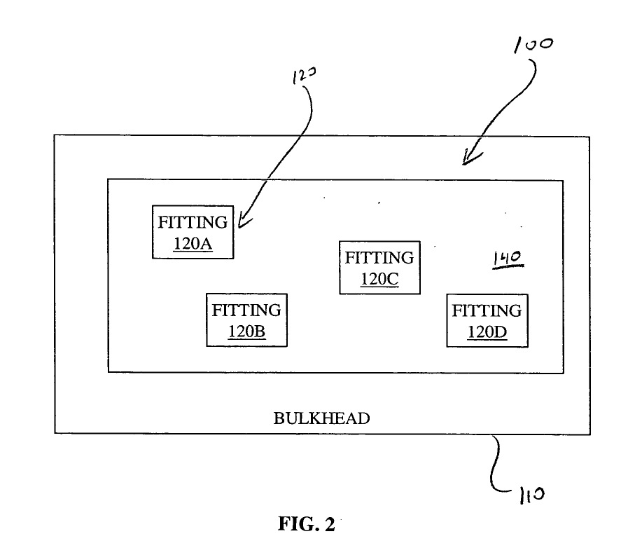

Referring to FIG. 2, coupler 100 includes one or more fittings 120, such as fittings 120a, 120b, 120c, 120d. Fittings 120 are coupled to respective tubes 116, 118 together as discussed in more detail below. Fittings 120 are loaded into and held by a holder 140 as described in more detail below. Coupler 110 includes a holder 140 that supports fittings 120 by locking fittings 120 together in a predetermined arrangement.

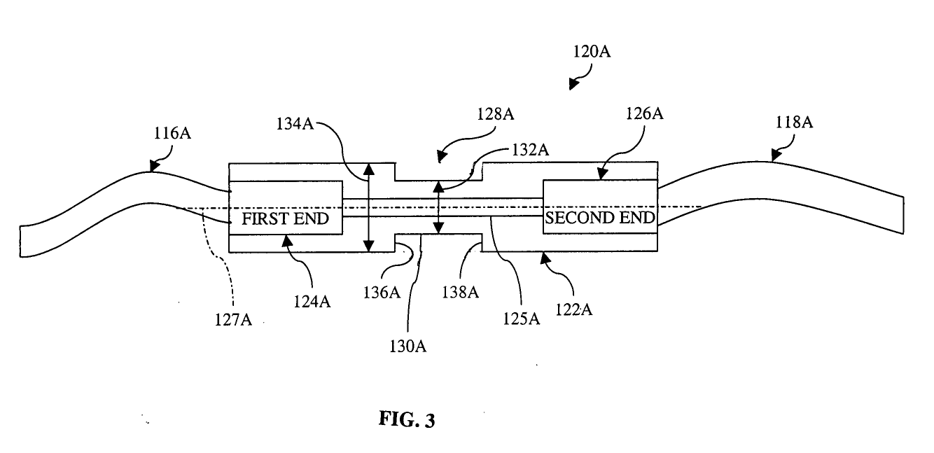

Referring to FIG. 3, an exemplary fitting 120A is shown. Fitting 120A includes a housing or body 122A, a first end 124A, a second end 126A, and a passage 125A connecting first end 124A and second end 126A. Passage 125A permits fluid to travel from one of first end 124A and second end 126A to the other of first end 124A and second end 126A. First end 124A couples to tube 116A and second end 126A couples to tube 118A. Various methods and structures for coupling a tube to a fitting are well known in the art. Therefore, although exemplary methods and structures of coupling a tube to a fitting are described herein, it should be understood that the present disclosure is not limited to the disclosed methods and structures for coupling a tube to a fitting.

Fitting 120A further includes a step 128A. Step 128A, as discussed in more detail below, interacts with holder 130 to secure fitting 120A relative to holder 130. Step 128A is shown as a negative step wherein a first step surface 130A has a smaller width 132A than a width 134A of housing 122A. Although first step surface 130A is shown as being generally parallel to longitudinal axis 127A, it is contemplated that the first step surface may be of any shape, such as tapered, rounded, convex, or concave.

Step 128A further includes a first side surface 136A and a second side surface 138A. Although first side surface 136A and second side surface 138A are shown as being generally straight, it is contemplated that first side surface and second side surface may be of any shape, such as tapered, rounded, convex, or concave.

Further, step 128A is shown as a negative step. In an alternative embodiment, the step is a positive step wherein the width of the step is larger than the width of the housing or body. In another alternative embodiment, the fitting includes multiple steps.

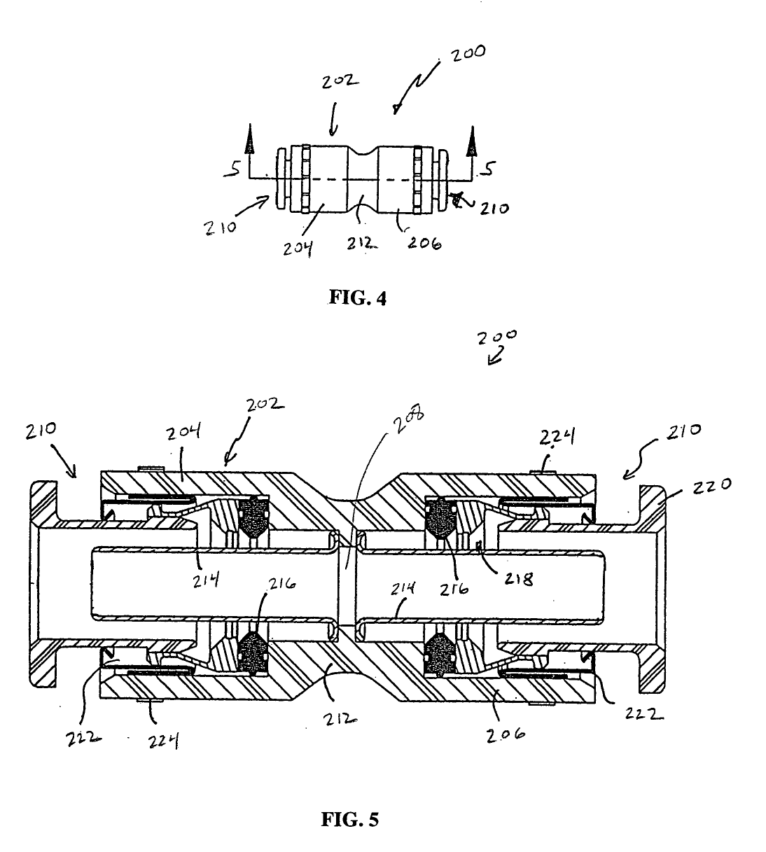

Referring to FIGS. 4-6, an exemplary fitting or connector 200 within the grouping of fittings characterized by fitting 120 is shown. Fitting 200 includes a housing or body 202, a first end 204, a second end 206, and a passage 208. First end 204 and second end 206 each includes a cartridge 210 that receives a tube (not shown) to provide fluid communication between the tubes. As shown in FIG. 4, first end 204 and second end 206 are receive cartridges 210 and housing 202 further includes a step or necked-down portion 212 positioned between ends 204, 206.

According to the preferred embodiment of the present disclosure, housing 202 of fitting 200 is made of PBT (Polybutylene Terephthalate) plastic. According to alternative embodiments of the present disclosure, the housing is made of other plastic materials, metals (such as stainless steel) or other materials known to those of ordinary skill in the art. According to the presently preferred embodiment, fittings 200 and the tubes connected thereto are configured to communicate air under positive or negative pressure. According to alternative embodiments, the connectors or fittings and tubes connected thereto are configured to communicate other fluids such as other gases, water, oil, or any other fluids known to those of ordinary skill in the art.

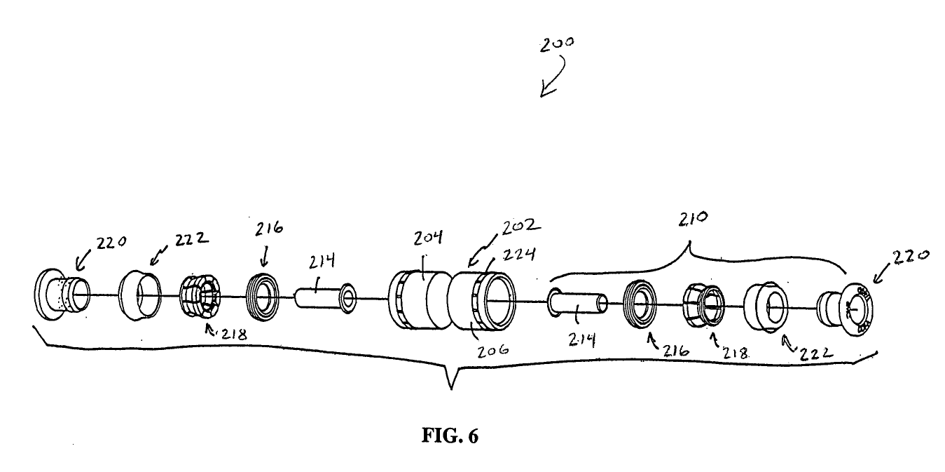

Referring to FIGS. 5 and 6, each cartridge 210 includes a tubular tube support 214 made of brass, an annular packing seal 216 made of NBR (nitrile) rubber, an annular tube chuck 218 made of brass, a tubular chuck release or release button 220 made of POM (polyoxymethylene, polyacetal) plastic, an annular guide 222 made of stainless steel or brass, and a stabilizing ring 224 made of a metal material. According to alternative embodiments of the present disclosure, other materials known to those of ordinary skill in the art are used for the various components such as other plastic materials and other metals. Additional details of these components and other alternative arrangements can be found in U.S. patent application Ser. No. 10/076,256, titled Pneumatic Coupling, to Pelfrey et al., filed Feb. 13, 2002, the disclosure of which is expressly incorporated by reference herein including the disclosure of U.S. Pat. Nos. 5,333,647; 5,459,953; 5,725,255; 6,062,260; and 6,131,610.

Referring to FIGS. 7-16 an exemplary coupler 300 of the present disclosure is shown. Coupler 300 includes a holder 301 and a plurality of fittings or connectors 304. Holder 301 includes a base member 302 and at least one retainer 306. Fittings 304 are selected from any suitable fittings, such as fittings 120, 200 described above. When fully assembled, base member 302 and retainers 306 support fittings 304 by locking fittings 304 together in a predetermined arrangement as shown in FIG. 7.

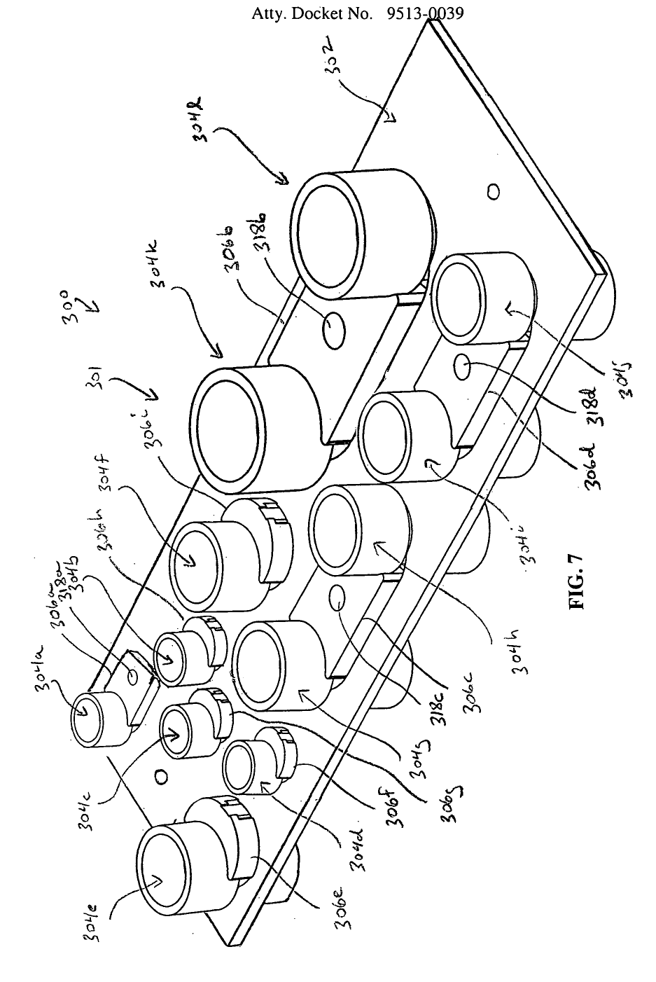

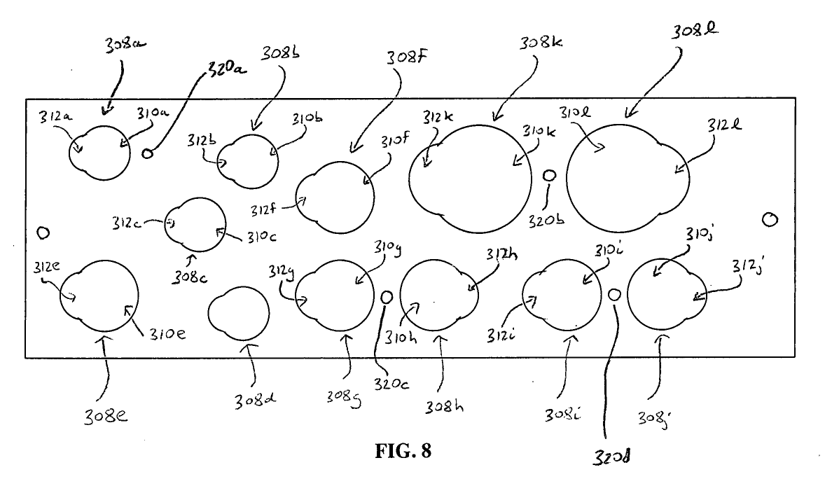

Base member 302, in one embodiment, is flat plate as shown in FIGS. 7 and 8. In alternative embodiments the base member has a profile selected from one of a linear profile, a curved profile, a step profile, or any other suitable profile known to one of ordinary skill in the art. Preferably, base member 302 has a profile that matches the profile of the particular bulkhead that base member 302 is coupled thereto.

According to the preferred embodiment of the present disclosure, base member 302 is made of anodized aluminum. According to alterative embodiments of the present disclosure, the base member is made of a different thickness and/or made of other metal materials, plastic materials, composites, or any other materials known to those of ordinary skill in the art.

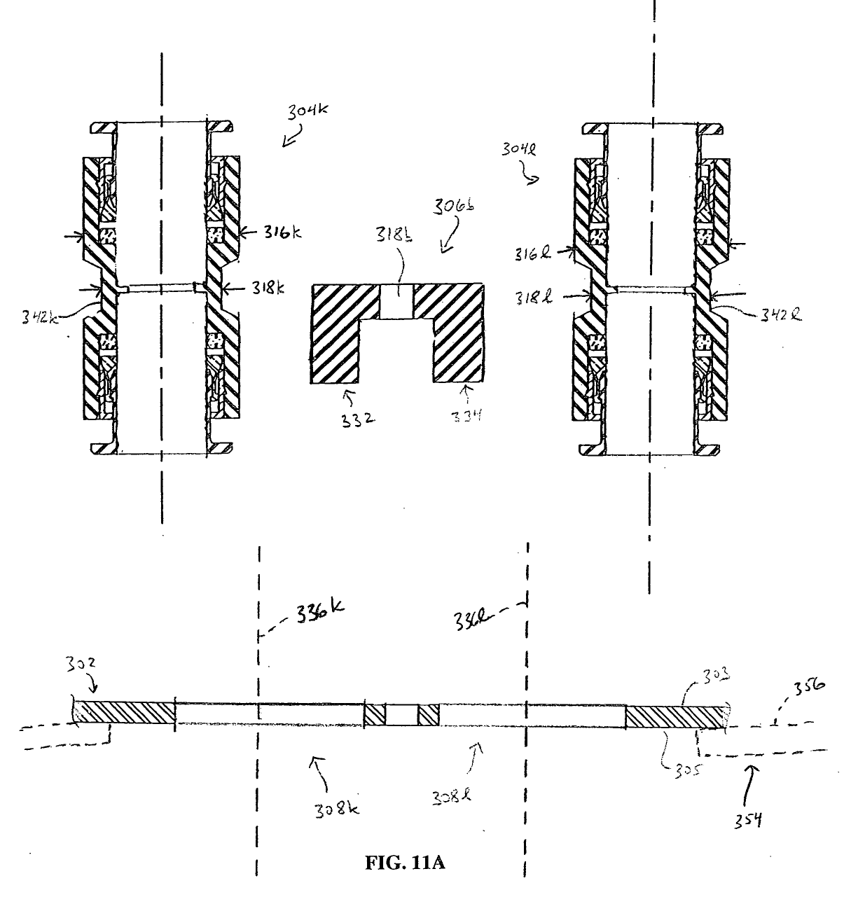

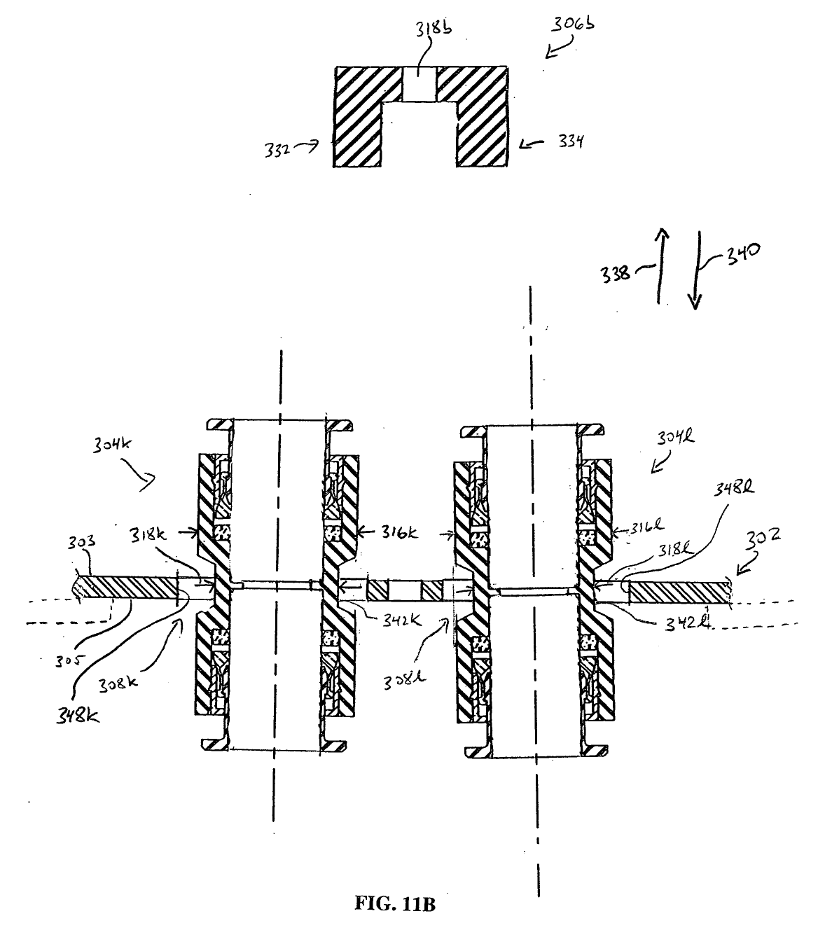

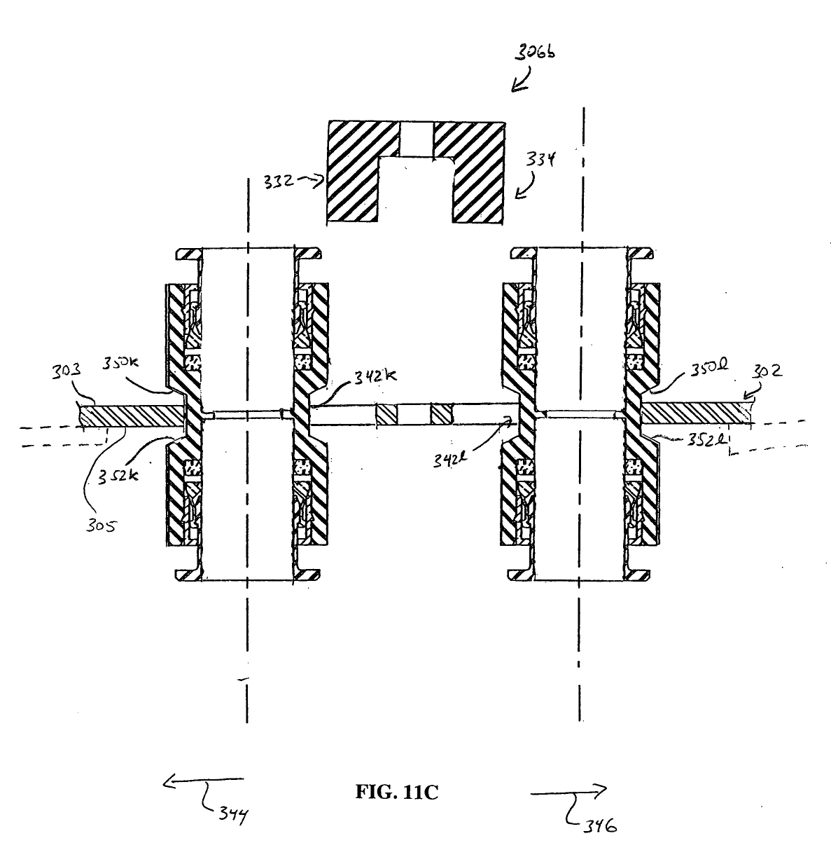

Referring to FIG. 8, base member 302 includes a plurality of apertures 308 formed therein, each of the plurality of apertures receive a respective one of plurality of fittings 304. Each of the plurality of apertures 308 includes a first portion 310 for receiving a portion of respective fitting 304 when fittings 304 are being loaded into base member 302 and a second portion 312 for interacting with a negative step or necked down portion 314 (shown in FIGS. 11A-D) of respective fittings 304 when fittings 304 are secured to base member 302.

In a preferred embodiment first portion 310 is sized such that a diameter or width 316 of fitting 304 is able to pass through first portion 310 and second portion 312 is sized to be smaller than width 316 and preferably generally about equal to a width 318 of step 314 of fitting 304.

In the illustrated embodiment fittings 304 and apertures 308 are of a variety of sizes. Fittings 304a-d are small-sized fittings; fittings 304e-j are medium-sized fittings; and fittings 304k, 304l are large-sized fittings. Apertures 308a-d are sized to accommodate small fittings 304a-d; apertures 308e-j are sized to accommodate medium fittings 304e-j; and apertures 308k, 308l are sized to accommodate large fittings 304k, 304l. According to alternative embodiments, the number and size of fittings and respective apertures may be of a greater or smaller size or of uniform size. According to an alternative embodiment of the present disclosure, the apertures in the base member are circular, rectangular, triangular, faceted, or any other shape known to those of ordinary skill in the art.

Returning to FIG. 7, each fitting 304a-l is secured to base member 302 with one of retainers 306a-h. Retainer 306a secures fitting 304a to base member 302. Retainers 306b-d secure two fittings to base member 302. For example, retainers 306b-d secure fittings 304k, 3041; fittings 304g, 304h; and fittings 304i, 304j, respectively. Retainers 306e-h secure fittings 304e, 304d, 304c, 304b to base member 302, respectively. As such, retainers 306 may secure one or more fittings to base member 302. In an alternative embodiment, a retainer is secures at least two different size fittings to the base member. In another alternative embodiment, three or more fittings are secured to the base member with a single retainer, generally similar to retainer 306b.

In the preferred embodiment, retainers 306 are made from DELRIN® polyacetal or polyamide (nylon). In alternative embodiments, the retainers are made from other plastics and moldable materials, metals, composites or other suitable materials known to those of ordinary skill in the art.

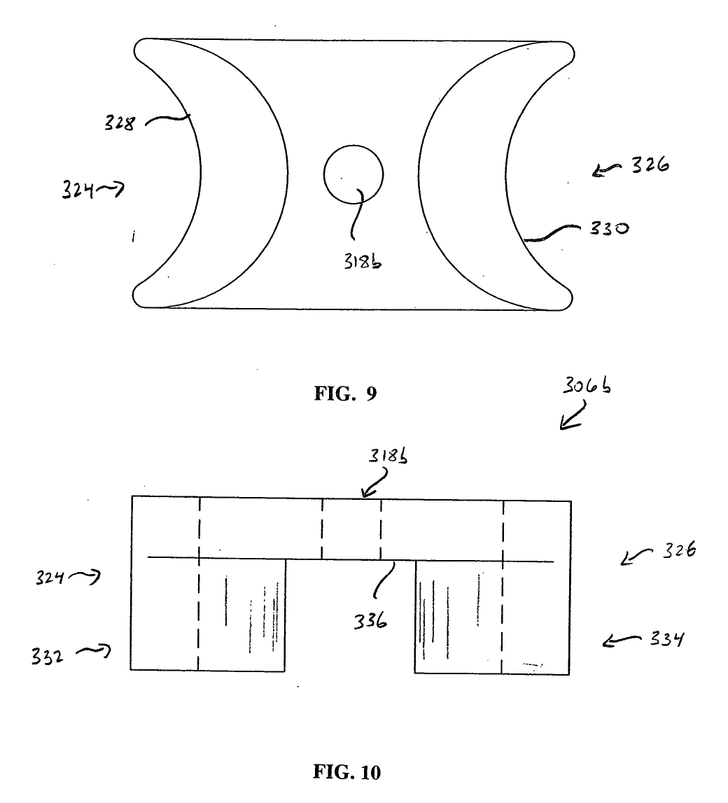

The illustrated retainers in FIGS. 7 and 8 are secured to base member 302 by one of two securing means. Retainers 306a-d are secured to base member 302 with a fastener (not shown), such as a screw, bolt, or other suitable fastener. The respective fasteners (not shown) are received in fastener-receiving apertures 318a-d in respective retainers 306a-d and by fastener-receiving apertures 320a-d and (not shown) in base members 302. The fastener-receiving apertures 320a-d are spaced apart from the respective apertures 308 in base member 302. Further details of the operation and structure of retainers 306a-d is provided below in connection with FIGS. 9-11.

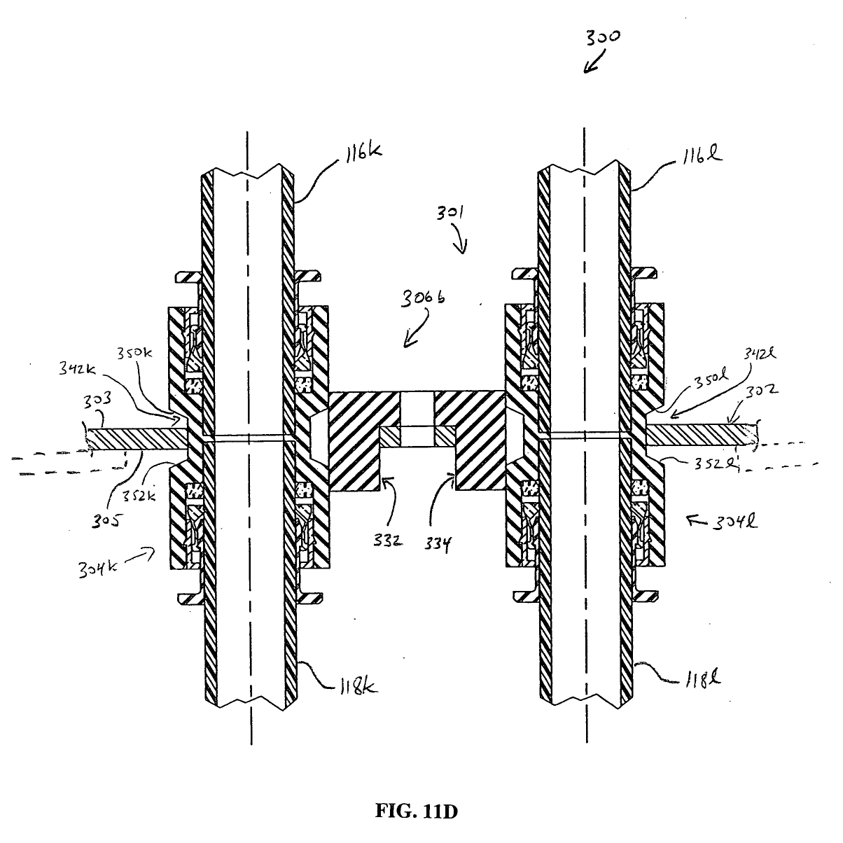

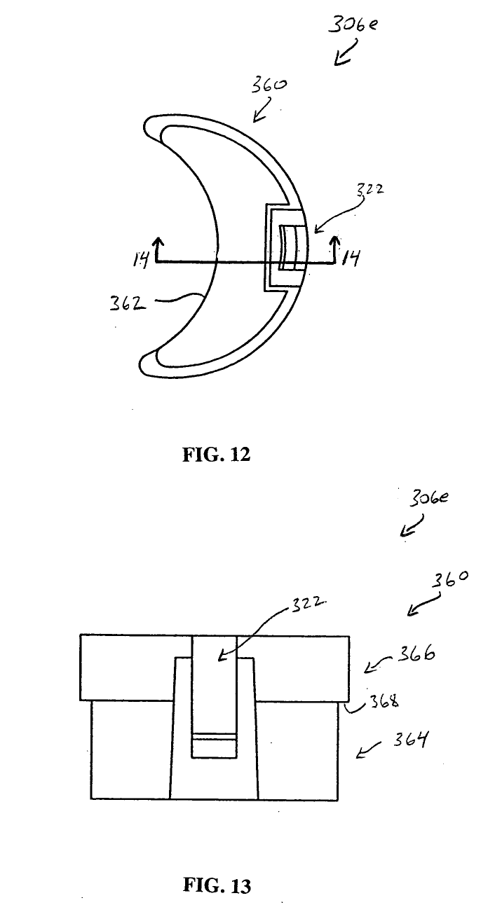

Retainers 306e-h are secured to base member 302 with a fastener 322 (shown in FIGS. 12-16). In the illustrated embodiment, each respective fastener 322 is a flexible tang or latch which secures the respective retainer to base member 302. Further details of the operation and structure of retainers 306a-d is provided below in connection with FIGS. 12-16.

Referring to FIGS. 9 and 10, retainer 306b is illustratively shown. It should be understood that the following discussion related to retainer 306b is applicable to retainers 306c and 306d as well as retainer 306a, except that retainer 306a secures a single fitting (fitting 304a), not multiple fittings.

Retainer 306b includes a fastener-receiving aperture 318b to receive a fastener (not shown) to secure retainer 306b to base member 302, a first fitting-receiving portion 324 and a second fitting-receiving portion 326. First fitting-receiving portion 324 and second fitting-receiving portion 326 include a fitting surface 328, 330, respectively. Fitting surfaces 328, 330 generally are shaped to match the profile of fittings 304k, 304l, respectively. Fitting surfaces 328, 330 are illustratively shown as being arcuate. However, fitting surfaces 328, 330 can be any shape that generally matches the profile of the respective fittings that it secures. Further, in alternative embodiments, the fitting surfaces can match a smaller or greater extent of the profile of the respective fittings.

Referring to FIG. 10, retainer 306b further includes a first retainer member 332 and a second retainer member 334. First and second retainer members 332, 334 extend downward from a lower surface 336 of retainer 306b and are positioned within apertures 308k, 308l of base member 302, respectively. Referring to FIG. 11D, when first and second retainer members 332, 334 are positioned in apertures 308k, 308l, respectively, fittings 304k, 304l are secured in apertures 308k, 308l, respectively, as explained in more detail below.

FIGS. 11A-D illustrate the manner in which fittings 304k, 304l are secured to base member 302 with retainer 306b. Fittings 304k, 304l are generally secured to base member 302 in generally the same manner. As such, the following discussion although applicable to both fittings 304k, 304l will detail only the manner in which fitting 304k is secured to base member 302.

Referring to FIG. 11A, base member 302 is shown along with fittings 304k, 304l and retainer 306b, each of which is spaced apart from base member 302. Aperture 308k is shown having a longitudinal axis 336k. Referring to FIG. 11B, coupler 300 is shown in a loading configuration wherein fitting 304k is positioned in aperture 308k and moveable relative to base member 302 in directions 338, 340 along longitudinal axes 336k. During loading, fitting 304k is generally positioned in first portions 310k of the respective apertures 308k. Fitting 304k is properly positioned in aperture 308k when step 342k is generally positioned in aperture 308k.

Referring to FIG. 11C, once step 342k is generally positioned in aperture 308k, fitting 304k is moved transversely in direction 344 (direction 346 for fitting 304l) such that step 342k is generally brought into contact with surface 348k that defines second portions 312k of aperture 308k. The placement of step 342k in second portion 312k limits or restricts the movement of fitting 304k in directions 338, 340 due to the abutment of step side surfaces 350k, 352k with base member 302. However, as shown in FIG. 11C, fitting 304k may still move transversely in direction 346 such that fitting 304k is once again free to move in directions 338, 340.

Fitting 304k is maintained in position shown in FIG. 11C (step 342k interacting with base member 302 to restrict the movement of fitting 304k) by the placement of first retainer member 332 of retainer 306b in aperture 308k (second retainer member 334 maintains the position of fitting 304l). As shown in FIG. 11D, coupler 300 is in a secured configuration when retainer 306b is positioned such that first retainer member 332 is positioned in aperture 308k, second retainer member 334 is positioned in aperture 308l, and retainer 306b is fastened to base member 302. When retainer 306b is assembled, fitting surfaces 328 and 330 of retainer 306b abut or contact housing or body surface 355k of fitting 304k and housing or body surface 355l of fitting 304l, respectively. In the illustrated embodiment, a fastener (not shown) fastens retainer 306b to base member 302 through fastener-receiving apertures 318b of retainer 306b, 320b of base member 302.

As also shown in FIG. 11D, once fittings 304k, 304l are secured to holder 301, tubes 116k, 118k are connected to fitting 304k and tubes 116l, 118l are connected to fitting 304l.

Referring to FIGS. 12-16, the structure and operation of retainer 306e is illustratively shown. It should be understood that the following discussion related to retainer 306e is applicable to retainers 306f-h.

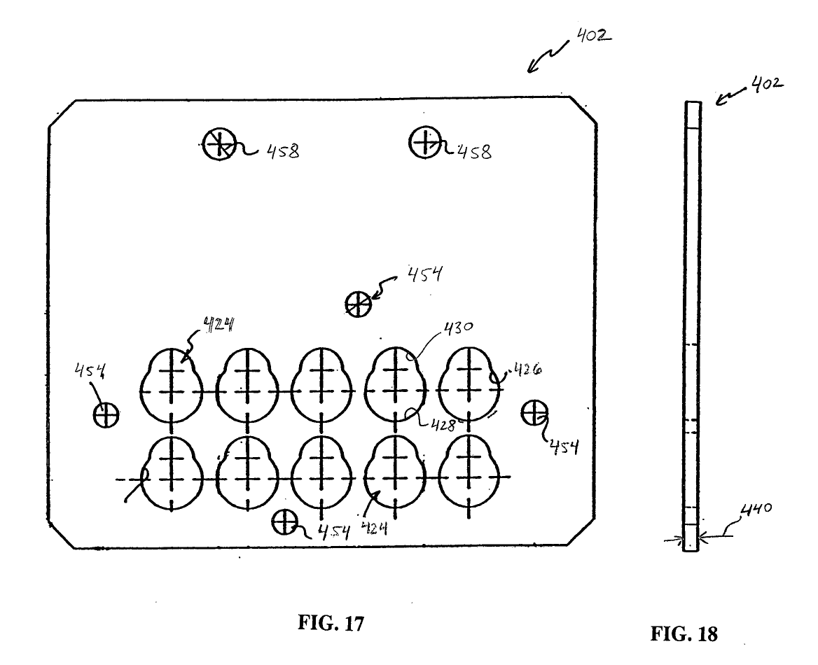

Retainer 306e includes a body member 360 and a fastener 322. Body member 360 includes a fitting surface 362 that matches the profile of fitting 304e, a lower portion 364 sized to be received by aperture 308e of base member 302, and an upper portion 366 sized such that upper portion 366 will not pass into aperture 308e when fitting 304e is positioned in aperture 308e. As shown in FIG. 17, a lower surface 368 of upper portion 366 abuts or contacts upper surface 303 of base member 302 when retainer 306e is positioned in aperture 308e along with fitting 308e.

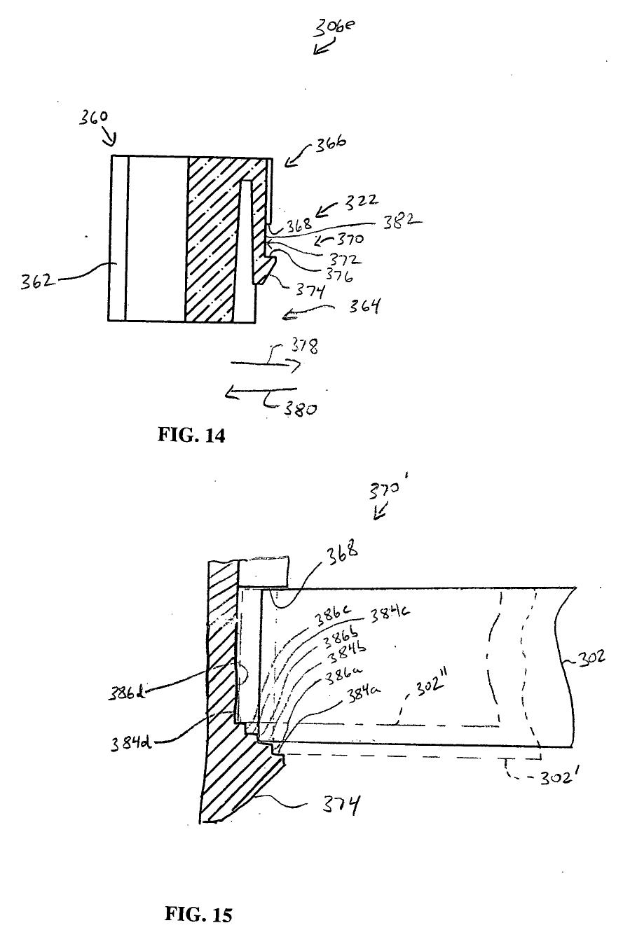

Referring to FIG. 14, fastener 322 includes a tang or latch member 370 having an arm 372, a lead-in surface 374, and a catch surface 376. Latch member 370 is flexible generally in directions 378 and 380 is biased towards the generally vertical configuration shown in FIG. 14.

Retainer 306e secures fitting 304e to base member 302 in a manner generally similar to the method that fittings 304k is secured to base member 302 with retainer 306b, as described above in connection with FIGS. 11A-D. First fittings 304e is positioned in aperture 308e of base member 302 while retainer 306e is spaced apart from base member 302. Once fitting 304e is positioned in aperture 308e, coupler 300 is in a loading configuration and is moveable relative to base member 302 in directions 338, 340 along a longitudinal axis (not shown) of aperture 308e with fitting 304e generally positioned in first portion 310e of apertures 308e. Fitting 304e is properly positioned in aperture 308e when step 342e is generally positioned in aperture 308e.

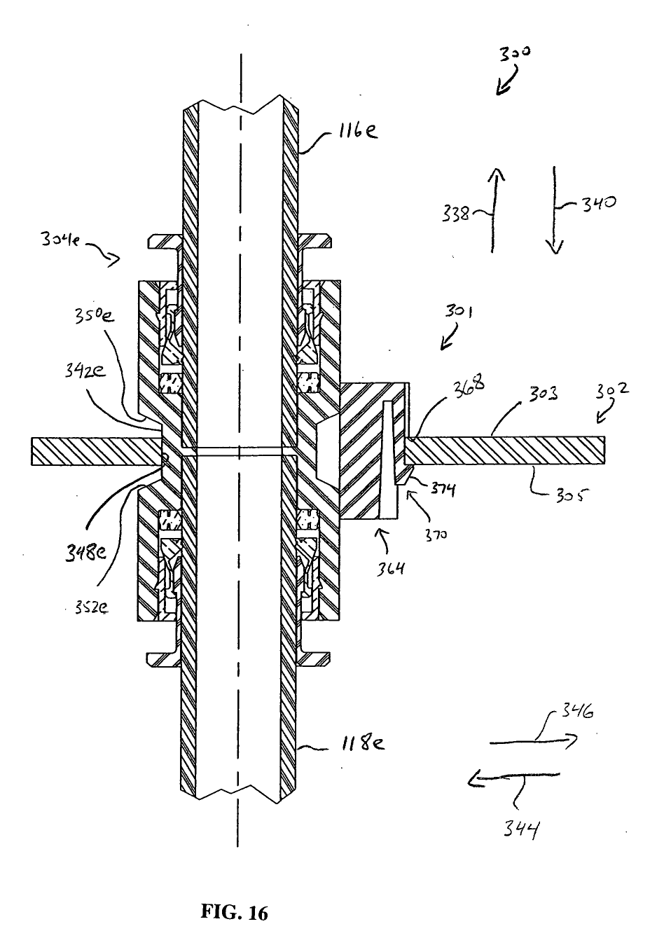

Once step 342e is generally positioned in aperture 308e, fitting 304e is moved transversely in direction 344 such that step 342e is generally brought into contact with surface 348e that defines second portions 312e of aperture 308e. The placement of step 342e in second portion 312e limits or restricts the movement of fitting 304e in directions 338, 340 due to the eventual abutment of step side surfaces 350e, 352e with base member 302. Step 342e is maintained in second portion 312e by the placement of lower portion 364 of retainer 306e in aperture 308e. As shown in FIG. 16, coupler 300 is in a secured configuration when retainer 306e is positioned such that lower portion 364 is positioned in aperture 308e, and latch member 370 is positioned such that catch surface 376 is adjacent bottom surface 305 of base member 302. When retainer 306e is assembled, fitting surface 362 of retainer 306e abut or contact housing or body surface 355e of fitting 304e.

As retainer 306e is moved along direction 340 from a spaced-apart relation to base member 302 to the configuration shown in FIG. 17, lead-in surface 374 contacts surface 348e of aperture 308e (more precisely the intersection of surface 348e and base member top surface 303). As retainer 306e is moved further in direction 340, lead-in surface 374 due to its ramped configuration causes arm 372 to flex generally in direction 344 such that latch member 370 is compressed towards body member 360. Once retainer 306e reaches the configuration shown in FIG. 17, lead-in surface 374 clears surface 348e of aperture 308e and arm 372 returns generally to its original configuration by moving in direction 346.

Abutment of surface 368 of body member 360 with top surface 303 of base member 302 prevents retainer 306e from moving further in direction 340. Abutment of catch surface 376 of latch member 370 with bottom surface 305 of base member 302 prevents retainer 306e from moving in direction 338. In one embodiment, the abutment of a arm surface 382 and aperture surface 348e and the corresponding abutment of fitting surface 362 and fitting 304e prevents the movement of fitting 304e in directions 344, 346.

As also shown in FIG. 16, once fittings 304e are secured to holder 301, tubes 116e, 118e are connected to fitting 304e. These connections provide fluid communication between tubes 116e, 118e.

Referring to FIG. 15, an alternative embodiment latch member 370′ is shown. Latch member 370′ is generally similar to latch member 370 except that latch member 370′ functions with base members having different thickness. Latch member 370′ includes multiple catch surfaces 384a-d and multiple corresponding arm surfaces 386a-d. Catch surface 384a and arm surface 386a interact with a thicker base member 302′ while catch surface 384d and arm surface 386d interact with a thinner base member 302″. Catch surface 384b and arm surfaces 386b interact with base member 302. Catch surface 384c and arm surfaces 386c, 386c interact with a base member whose thickness is between the thickness of base member 302 and base member 302″.

Coupler 300 allows fittings, such as fittings 304k, to be assembled to a bulkhead 354 from one side of bulkhead 354 (illustratively shown as being assembled from a first side 356 of bulkhead 354). As such, coupler 300 allows a single person to assemble fittings to a bulkhead.

Referring to FIGS. 17-24, an exemplary coupler 400 according to a preferred embodiment of the present disclosure is shown. Coupler 400 includes a holder 401 including an inner plate or base member 402 and a pair of outer plates or retainers 404, a plurality of connectors or fittings, such as fittings 304, and a plurality of fasteners (not shown). Inner and outer plates 402, 404 clamp or otherwise couple connectors 304 together in a predetermined arrangement.

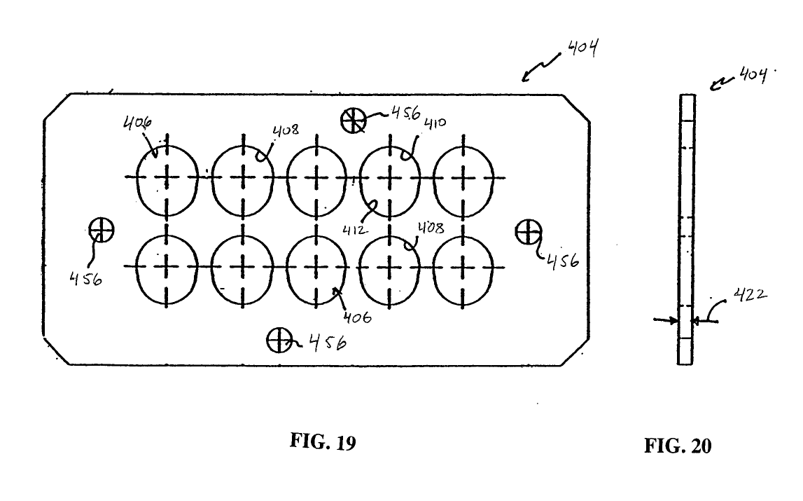

When fully assembled, inner and outer plates or retainers 402, 404 supports connectors 304 by locking connectors 304 together in a predetermined arrangement as shown in FIG. 24 for one of fittings 304. Outer plates 404 includes a plurality of apertures 406 defined by edges 408 as shown best in FIG. 19. Each edge 408 includes first and second circular portions 410, 412 as shown in FIGS. 19, 21, and 23. First portion 410 defines a first opening 414 with a width 416 slightly larger than a width 316 of cartridge-receiving portions or housing or body of connectors 304. Second portion 412 defines a second opening 418 with a width 420 that is approximately equal to width 316 of cartridge-receiving portion or housing or body of fitting 304.

According to the preferred embodiment of the present disclosure, outer plates 404 have ten apertures 406, are made of aluminum, anodized, and have a thickness 422 of 3.2 millimeter. Width 416 is equal to 13.9 millimeters and width 420 is equal to 13.2 millimeters. According to alterative embodiments of the present disclosure, the plates are of a different thickness and/or made of other metal materials, plastic materials, composites, or any other materials known to those of ordinary skill in the art. Furthermore, more or fewer (such as one or more) apertures may be provided in the outer plates. Such apertures may be of greater or smaller size than the preferred embodiment and may be of a variety of sizes. According to an alternative embodiment of the present disclosure, the apertures in the outer plates are circular, rectangular, triangular, or any other shape known to those of ordinary skill in the art.

Inner plate or base member 402 includes a plurality of apertures 424 defined by edges 426 as shown best in FIG. 18. Each edge 426 includes first and second circular portions 428, 430 as shown in FIG. 18. First portion 428 defines a first opening 432 with a width 434 slightly larger than width 316 of cartridge-receiving portions of connectors 304. Second portion 430 defines a second opening 436 with a width 438 that is approximately equal to the width of necked-down or step portion 342 of connectors 304.

According to the preferred embodiment of the present disclosure, inner plate or base member 402 has ten apertures 424, are made of aluminum, anodized, and have a thickness 440 of 3.2 millimeter. Width 434 is equal to 13.9 millimeters and width 438 is equal to 10 millimeters. According to alterative embodiments of the present disclosure, the inner plate is made of a different thickness and/or made of other metal materials, plastic materials, composites, or any other materials known to those of ordinary skill in the art. Furthermore, fewer or more apertures may be provided in the inner plates. Such apertures may be of greater or smaller size than the preferred embodiment and may be of a variety of sizes. According to an alternative embodiment of the present disclosure, the apertures in the outer plates are circular, rectangular, triangular, or any other shape known to those of ordinary skill in the art.

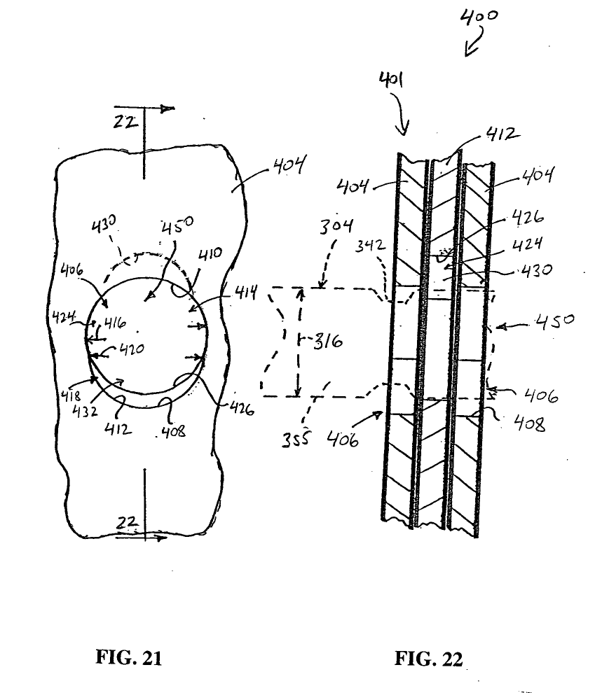

To assemble coupler 400, inner plate or base member 402 is positioned between outer plates 404 so that openings 414 of outer plates 404 are aligned with openings 432 of inner plate or base member 402 as shown in FIGS. 21 and 22. When aligned, plates 402, 404 cooperate to define a substantially circular passage 450 as shown in FIG. 21. Passage 450 is slightly wider than width 316 of cartridge-receiving portion of connectors 316 to permit connectors 304 to be inserted into plates 402, 404 as shown in FIG. 22. Each connector 304 is inserted into its respective passage 450 until necked-down or step portion 342 is positioned in apertures 424 of inner plate or base member 402.

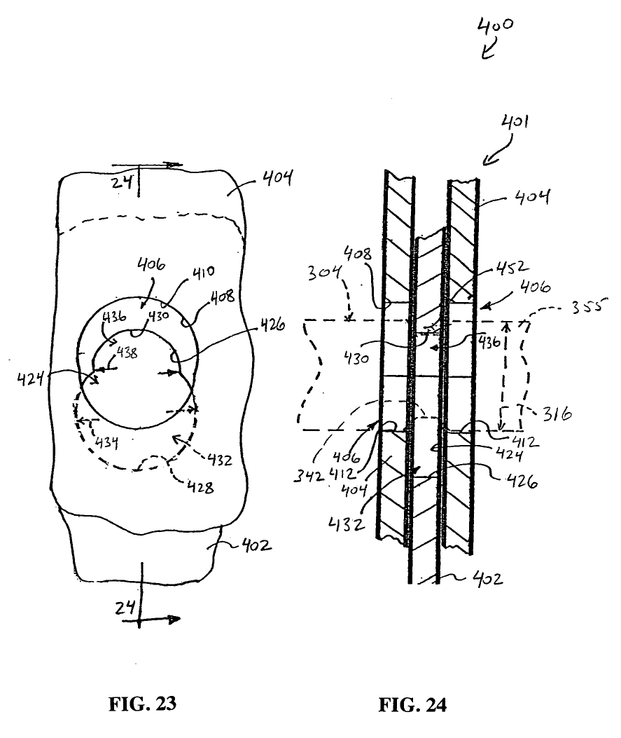

Then inner plate or base member 402 is moved downward relative to outer plates 404 as shown in FIGS. 23 and 24. This movement reduces the cross-sectional area of passage 450 and moves second portion 430 of edge 426 of inner plate or base member 402 into contact with necked-down or step portion 342 of each connector 304. Furthermore, second portions 412 of edges 408 of outer plates 404 move into contact with cartridge-receiving portions of connectors 304. Because a portion 452 of inner plate or base member 402 is positioned between cartridge-receiving portions of connector 304 (as shown in FIG. 24), connector 304 can not be removed from plates 402, 404. According to alternative embodiments of the present disclosure, other coupling arrangements are provided. For example, according to one embodiment, other configurations of necked-down portions or other voids known to those of ordinary skill in the art are provided to trap a portion of the inner or outer plates. According to other alternative embodiments of the present disclosure, other shapes and sizes of voids known to those of ordinary skill in the art are provided on either the connector or the plates.

As shown in FIGS. 17 and 19, inner and outer plates 402, 404 further include a plurality of fastener-receiving apertures 454, 456. After moving inner and outer plates 402, 404 to the position shown in FIGS. 23 and 24, apertures 454, 456 are aligned to receive fasteners (not shown) to couple inner and outer plates 402, 404 together. According to the preferred embodiment of the present disclosure, the fasteners (not shown) are rivets. After coupler 400 is assembled, it is coupled to an end product (such as a bulkhead, a vehicle fire wall or other portion of a vehicle, manufacturing equipment, control equipment, or any other end product known to those of ordinary skill in the art) using fastener-receiving apertures 458 provided in inner plate or base member 402. According to alternative embodiments of the present disclosure, other fasteners such as screws, bolts, clips, adhesives, welds, brazing, or another fastening devices known to those of ordinary skill in the art are provided.

Preferably, instructions for the assembly, installation, and/or use of coupler 100, coupler 300, or coupler 400 are provided with coupler 100, coupler 300, or coupler 400 or otherwise communicated to permit a person or machine to assemble, install and/or use coupler 100, coupler 300, or coupler 400. Such instructions may include a description of any or all portions of coupler 100, coupler 300, or coupler 400 and/or any or all of the above-described assembly, installation, and use of coupler 100, coupler 300, or coupler 400. Furthermore, such instructions may describe the environment in which coupler 100, coupler 300, or coupler 400 is used. The instructions may be provided on separate papers and/or the packaging in which coupler 100, coupler 300, or coupler 400 is sold or shipped. Furthermore, the instructions may be embodied as text, pictures, audio, video, or any other medium or method of communicating instructions known to those of ordinary skill in the art.

Unless otherwise stated, the figures are proportional. While this invention has been shown and described as having multiple designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A coupler configured to couple a plurality of first and second tubes together, the coupler comprising:
a plurality of fittings, each fitting including a fitting body having a step, a first end adapted to be coupled to a first tube, a second end adapted to be coupled to a second tube to provide fluid communication between the first and second tubes;
a base member including a plurality of apertures configured to receive the plurality of fittings, the base member interacting with the step of the plurality of fittings to restrict the movement of the plurality of fittings; and
a retainer, coupled to the base member to secure at least one of the plurality of fittings to the base member.

2. The coupler of claim 1, wherein a first fitting of the plurality of fittings has a width positioned in a first aperture of the plurality of apertures, the first aperture has a width, the width of the first aperture being greater than the width of the first fitting.

3. The coupler of claim 2, wherein the step of the first fitting is a negative step sized to be engaged by a surface of the base member that defines the first aperture, with the retainer being configured to position the negative step of the first fitting in engagement with the surface of the base member that defines the first aperture when the retainer is in a securing configuration.

4. The coupler of claim 3, wherein the first retainer member includes a fastener to secure the first retainer member to the base member in the securing configuration.

5. The coupler of claim 4, wherein the first retainer member is positionable in the first aperture along with the first fitting, wherein the first retainer member positions the fastener to engage at least one edge surface defining the first aperture to secure the first retainer member to the base member.

6. The coupler of claim 5, wherein a first fitting has a negative step, the first fitting is positioned in a first aperture of the plurality of apertures of the base member and a first aperture of the plurality of apertures of the first retainer member, the negative step of the first fitting being sized to be engaged by a surface of the base member that defines the first aperture of the base member, and the first retainer member is configured to position the negative step of the first fitting in engagement with the surface of the base member that define the first aperture of the base member when the holder is in the securing configuration.

7. The coupler of claim 6, wherein a first aperture of the base member is defined by a surface having a first portion which is sized to receive the first fitting when the first fitting is in a loading configuration and a second portion which is configured to engage the step of the first fitting when the holder is in a securing configuration.

8. A coupler configured to couple a plurality of first and second tubes together at a bulkhead, the bulkhead having a first side and a second side, the coupler comprising:
a base member adapted to be coupled to the bulkhead, the base member having a first side which is accessible from the first side of the bulkhead, a second side which is accessible from the second side of the bulkhead, and a plurality of apertures extending from the first side of the base member to the second side of the base member;
a plurality of fittings, each fitting having a first end adapted to be coupled to a first tube and a second end adapted to be coupled to a second tube, each of the plurality of fittings being received by the respective aperture of the plurality of apertures from the first side of the base member; and
at least one retainer configured to secure at least one of the plurality of fittings to the holder, the at least one retainer being positioned from the first side of the holder such that at least one of the plurality of fittings is coupled to the holder.

9. The coupler of claim 8, wherein the step of a first fitting of the plurality of fittings is a negative step and is sized to be engaged by a surface of the base member that defines the first aperture and the at least one retainer includes a first retainer member which is positioned in the negative step of the first fitting to engage with the surface of the base member to secure the first fitting to the base member.

10. The coupler of claim 9, wherein the first retainer member is positioned in the first aperture along with the first fitting and the first retainer member includes a fastener configured to engage at least one edge surface that defines the first aperture to secure the retainer to the base member.

11. The coupler of claim 10, wherein the first retainer member is positioned in the first aperture along with the first fitting and the first retainer member includes a fastener configured to engage a portion of the base member spaced apart from the first aperture to secure the retainer to the base member.

12. A coupler configured to couple a plurality of first tubes to a plurality of second tubes, the coupler comprising:
a base member including a plurality of apertures;
a plurality of fittings, each having a first end adapted to be coupled to a first tube, a second end adapted to be coupled to a second tube, with a first of the plurality of fittings adapted to extend through a first aperture of the plurality of apertures; and
a retainer, to secure the first fitting in the first aperture of the plurality of apertures, the retainer adapted to extend through the first aperture adjacent the first of the plurality of fittings.

13. The coupler of claim 12, wherein the first of the plurality of fittings includes a negative step sized to interact with an edge that defines the first aperture.

14. The coupler of claim 13, wherein the retainer is configured to block removal of the negative step of the first fitting from the edge.

15. The coupler of claim 14, wherein the retainer includes an aperture, adapted to receive a fastener and to couple the retainer to the base member.

16. The coupler of claim 14, wherein the retainer includes a fastener, to couple the retainer to the base member.

17. The coupler of claim 16, wherein the fastener includes a flexible latch.

18. The coupler of claim 17, wherein the fastener includes a catch adapted to engage a surface of the base member.

19. The coupler of claim 12, wherein a second of the plurality of fittings is adapted to extend through the first of the plurality of apertures.

20. The coupler of claim 19, wherein the retainer couples the first and the second plurality of fittings to the first of the plurality of apertures.
